(19) United States
(12) Patent Application Publication
(10) Pub. No.: US 2025/0310152 A1
(43) Pub. Date: Oct. 2, 2025

(54) SYSTEM AND METHODS FOR GENERATING CORRECTED CHANNEL IMPULSE RESPONSE ESTIMATE

(71) Applicant: Qorvo US, Inc., Greensboro, NC (US)

(72) Inventors: Marco Cavaliere, Dublin (IE); Michael McLaughlin, Dublin (IE)

(21) Appl. No.: 19/060,557

(22) Filed: Feb. 21, 2025

Related U.S. Application Data
(60) Provisional application No. 63/571,753, filed on Mar. 29, 2024.

(51) Int. Cl. H04L 25/02

(52) U.S. Cl. CPC H04L 25/0212; H04L 25/0242; H04L 25/0254; H04L 25/0256

(57) ABSTRACT

A method is provided for generating a corrected channel impulse response (CIR) estimate by a receiver of a ultra-wideband (UWB) device. The method includes, computing a correction matrix based on a sequence of chips, a number of the chips being N; receiving a pulse signal corresponding to the sequence of chips, the pulse signal being a multi-path propagated signal corresponding to a non-zero chip in the sequence of chips; determining a CIR estimate for the pulse signal; and computing the corrected CIR estimate for the pulse signal based on the correction matrix and the CIR estimate.

### CROSS-REFERENCE TO RELATED APPLICATIONS

The present application claims the benefit of U.S. Provisional App. No. 63/571,753, entitled “SYSTEM AND METHODS FOR GENERATING CORRECTED CHANNEL IMPULSE RESPONSE ESTIMATE” and filed on Mar. 29, 2024, which is hereby incorporated by reference in its entirety.

### FIELD OF THE DISCLOSURE

The present disclosure relates to channel estimation in ultra-wideband (UWB) communication, in particular, to system and methods for generating a corrected channel impulse response (CIR) estimate.

### BACKGROUND

Ultra-wideband (UWB) is a wireless communication technology that uses a wide bandwidth, typically about 500 MHz or larger, or has a 10 dB bandwidth greater than 20% of the center frequency. Impulse UWB (IR-UWB) is a specific case of UWB in which the signal is transmitted in very short pulses (in the order of nano seconds). It is particularly adapted for ranging or sensing application as the pulses are robust against multipath. Another advantage of IR-UWB is its ability to transmit data with very low power consumption and latency.

Radar systems, including UWB-based radars, can be used to sense the environment by providing a means of obtaining propagation channel measures. The propagation channel is due to the reflections of the transmitted signal on the environment. The channel measures usually take the form of a set of periodic channel impulse response (CIR estimate) estimates. Each CIR estimate's complex components (taps) corresponds to a propagation delay of the reflected signal and thus to a reflecting target's distance. In a mono-static radar such as a transceiver, the CIR estimate may contain some saturated taps in the short distance range because of the strong spillover of the transmitted signal directly from the transmitter (TX) antenna to the receiver (RX) antenna. Saturated taps are blind, they do not contain information anymore and thus cannot be used for radar post-processing purposes. Thus, a method and a system to estimate CIR estimate to reduce the impact of spillover are desired.

### SUMMARY

An aspect of the present disclosure provides a method for generating a corrected (e.g., cleaner) channel impulse response (CIR) estimate by a receiver of a ultra-wideband (UWB) device. In some embodiments, a cleaner CIR estimate may refer to a CIR estimate without or with minimum/reduced artifacts or replicas. The method includes, computing a correction matrix based on a sequence of chips, a number of the chips being N; receiving a pulse signal corresponding to the sequence of chips, the pulse signal being a multi-path (including single path) propagated signal corresponding to a non-zero chip in the sequence of chips; determining a CIR estimate for the pulse signal; and computing the corrected (e.g., refined) CIR estimate for the pulse signal based on the correction matrix and the CIR estimate.

In some embodiments, the computing of the correction matrix includes composing a first correction-element matrix to be a Toeplitz matrix of the sequence of chips; determining a corruption matrix from the sequence of chip, the corruption matrix being a diagonal matrix with diagonal elements being complementary of the sequence of chips; determining a second correction-element matrix to be a transpose of the first correction-element matrix; and computing the correction matrix to be a product of the first correction-element matrix, the corruption matrix, and the second correction-element matrix.

In some embodiments, the correction matrix obtained above can also be calculated using other methods not directly mentioned above. In some embodiments, the correction matrix has minor modifications relative to the correction matrix obtained as described above.

In some embodiments, computing of the corrected CIR estimate for the pulse signal based on the correction matrix and the CIR estimate includes determining a number of columns of the correction matrix to be N_{g}, N_{g} being less than or equal to N; determining a reduced correction matrix to have the N rows of the correction matrix and N_{g} columns of the correction matrix; determining an actual correction matrix by computing a pseudo-inversion of the reduced correction matrix; and computing the corrected CIR estimate based on the actual correction matrix and the CIR estimate.

In some embodiments, a reduced number of rows can be used. In some embodiments, both numbers of columns and rows are less than N.

In some embodiments, the computing of the pseudo-inversion of the reduced correction matrix includes: determining a first part of the correction matrix to be a first block correction matrix, the first block correction matrix having a N_{g} rows of the correction matrix and a N_{g} columns of the correction matrix; determining a second part of the correction matrix to be a second block correction matrix, the second block correction matrix having a remaining (N−N_{g}) rows of the correction matrix and the N_{g} columns of the correction matrix; computing a second product of an inverted first block correction matrix and a transposed second block correction matrix.

In some embodiments, the determining of the CIR estimate includes: sampling the pulse signal to obtain a plurality of samples; filtering the plurality of samples using a correlation filter; dividing filtered samples into one or more groups based on a grid interval of the correlation filter, each of the groups having a length of the grid interval; and composing an initial CIR estimate from the plurality of groups, each of the one or more groups being a respective column of the initial CIR estimate.

In some embodiments, the computing of the corrected CIR estimate includes determining a first part of the initial CIR estimate to be a first partial CIR estimate, the first partial CIR estimate having a N_{g} rows of the initial CIR estimate; determining a second part of the initial CIR estimate to be a second partial CIR estimate, the second partial CIR estimate having a remaining (N−N_{g}) rows of the initial CIR estimate; and computing a sum of the first partial CIR estimate and a weighted third product of the second partial CIR estimate and the second product.

In some embodiments, the weight of the third product is greater than or equal to zero, and less than or equal to 1.

In some embodiments, the method further includes computing and storing the product of the inverted first block correction matrix and the transposed second block correction matrix prior to the computing of the CIR estimate.

In some embodiments, the sequence of chips include a perfect ternary sequence, or a non-perfect ternary sequence.

In some embodiments, the computing of the corrected CIR estimate based on the actual correction matrix and the CIR estimate includes obtaining a unique solution of the corrected CIR estimate by minimizing the least-squares error.

In some embodiments, the linear system of equations defined by the correction matrix (or its reductions) is solved (or approximated solution) using a different criterion than the least-squares error, or different methods than matrix (pseudo-) inversion.

Embodiments of the present disclosure provides an ultra-wide band (UWB) device. The UWB device includes a receiver operable to perform a UWB communication; a memory for storing program instructions, weight parameters, cipher codes, channel-impulse response (CIR) estimates accumulated from the cipher codes, and matrices for computing the CIR estimates; and a processor coupled to the receiver and to the memory. The processor is operable to execute the program instructions, which, when executed by the processor, cause the UWB device to perform the following operations, computing a correction matrix based on a sequence of chips, a number of chips being N; receiving a pulse signal corresponding to the sequence of chips, the pulse signal being a multi-path propagated signal corresponding to a non-zero chip in the sequence of chips; determining a CIR estimate for the pulse signal; and computing the corrected CIR estimate for the pulse signal based on the correction matrix and the CIR estimate.

In some embodiments, the computing of the correction matrix includes composing a first correction-element matrix to be a Toeplitz matrix of the sequence of chips; determining a corruption matrix from the sequence of chip, the corruption matrix being a diagonal matrix with diagonal elements being complementary of the sequence of chips; determining a second correction-element matrix to be a transpose of the first correction-element matrix; and computing the correction matrix to be a product of the first correction-element matrix, the corruption matrix, and the second correction-element matrix.

In some embodiments, computing of the corrected CIR estimate for the pulse signal based on the correction matrix and the CIR estimate includes: determining a number of columns of the correction matrix to be N_{g}, N_{g} being less than or equal to N; determining a reduced correction matrix to have the N rows of the correction matrix and N_{g} columns of the correction matrix; determining an actual correction matrix by computing a pseudo-inversion of the reduced correction matrix; and computing the corrected CIR estimate based on the actual correction matrix and the CIR estimate.

In some embodiments, the computing of the pseudo-inversion of the reduced correction matrix includes determining a first part of the correction matrix to be a first block correction matrix, the first block correction matrix having a N_{g} rows of the correction matrix and a N_{g} columns of the correction matrix; determining a second part of the correction matrix to be a second block correction matrix, the second block correction matrix having a remaining (N−N_{g}) rows of the correction matrix and the N_{g} columns of the correction matrix; computing a second product of an inverted first block correction matrix and a transposed second block correction matrix.

In some embodiments, the determining of the CIR estimate includes, sampling the pulse signal to obtain a plurality of samples; filtering the plurality of samples using a correlation filter; dividing filtered samples into one or more groups based on a grid interval of the correlation filter, each of the groups having a length of the grid interval; and composing an initial CIR estimate from the plurality of groups, each of the one or more groups being a respective column of the initial CIR estimate.

In some embodiments, the computing of the corrected CIR estimate includes determining a first part of the initial CIR estimate to be a first partial CIR estimate, the first partial CIR estimate having a N_{g} rows of the initial CIR estimate; determining a second part of the initial CIR estimate to be a second partial CIR estimate, the second partial CIR estimate having a remaining (N−N_{g}) rows of the initial CIR estimate; and computing a sum of the first partial CIR estimate and a weighted third product of the second partial CIR estimate and the second product.

In some embodiments, the weight of the third product is greater than or equal to zero, and less than or equal to 1.

In some embodiments, the UWB device further includes computing and storing the product of the inverted first block correction matrix and the transposed second block correction matrix prior to the computing of the CIR estimate.

In some embodiments, the sequence of chips include a ternary sequence.

In some embodiments the computing of the corrected CIR estimate based on the actual correction matrix and the CIR estimate includes obtaining a unique solution of the corrected CIR estimate by minimizing the least-squares error.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1A shows a corrupted CIR estimate with a spillover tap in related art.

FIG. 1B illustrates an example of a corrected CIR estimate, according to some embodiments of the present disclosure.

FIG. 2A illustrates a simplified block diagram of an exemplary communication system having a transmitter (TX) and a receiver (RX), according to some embodiments of the present disclosure.

FIG. 2B illustrates a simplified block diagram of a receiver for generating a corrected CIR estimate, according to some embodiments of the present disclosure.

FIGS. 2C and 2D show certain parameters used to compute the corrected CIR estimate, according to some embodiments of the present disclosure.

FIG. 3 shows a method for generating a corrected CIR estimate, according to some embodiments of the present disclosure.

FIG. 4A shows pulse signals in a TX signal, according to some embodiments of the present disclosure.

FIG. 4B shows a corrupted sampled RX signal caused by saturation of an analog-to-digital converter (ADC), according to some embodiments of the present disclosure.

FIG. 4C shows a comparison between a corrupted CIR estimate with a shadowing effect and a corrupted CIR estimate without a shadowing effect at different scales, according to some embodiments of the present disclosure.

FIG. 4D illustrates a comparison between a corrupted CIR estimate and a corrected CIR estimate at different scales, according to some embodiments of the present disclosure.

FIG. 5 illustrates a flowchart for generating a corrected CIR estimate, according to some embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several GHz or more, low spectral density, and short pulse width (e.g., 1 nano-second or nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchor devices). The present disclosure assumes that the user is carrying a device capable of communicating through UWB (referred to as “UWB-enabled device” or simply as “UWB device”).

In this disclosure, a symbol is a sequence of chips. Term “symbol,” term “code,” and term “sequence” may be used interchangeably. Each of these terms may correspond to/represent a sequence of UWB pulses. The term sequence may be in the form of a mathematical sequence of 1, −1, and 0.

As used herein, a tap in a channel impulse response (CIR estimate) estimate refers to a specific path through which a signal travels from the transmitter to the receiver.

A UWB exchange often involves transmitting sequences of pulses (e.g., symbols/sequences/codes such as ternary sequences) with good auto-correlation properties. An example of such sequence is Ipatov sequences. After cross-correlation in the receiver, the correlator output is high when it is perfectly aligned with the received sequence (main lobe), it is zero otherwise (sidelobe). This allows precise path identification and timestamp estimation.

In UWB monostatic sensing applications (e.g., a UWB transceiver), a strong signal is observed due to non-perfect isolation between the transmitter and the receiver, including the cross-talk between the transmitter and the receiver antennas. This signal is referred to as a spillover signal. In the receiver, if a lower gain is used to accommodate the strong spillover signal, weaker signals from targets can become difficult or impossible to detect. On the other hand, if a higher gain is used to detect weaker signals, the spillover signal saturates the analog-to-digital converter and has a shadowing/blinding effect on the other channel paths. This causes two main effects on delayed paths. The first effect is clipped paths, with some of the pulses of delayed paths are shadowed, and the main lobes of these paths are reduced. The second effect is the appearance of sidelobes or replicas of shadowed paths (e.g., signals that look like copies of the main lobe) that can be mistaken for real paths and can interfere with other paths. This is caused by the loss of perfect autocorrelation due to noise/contamination.

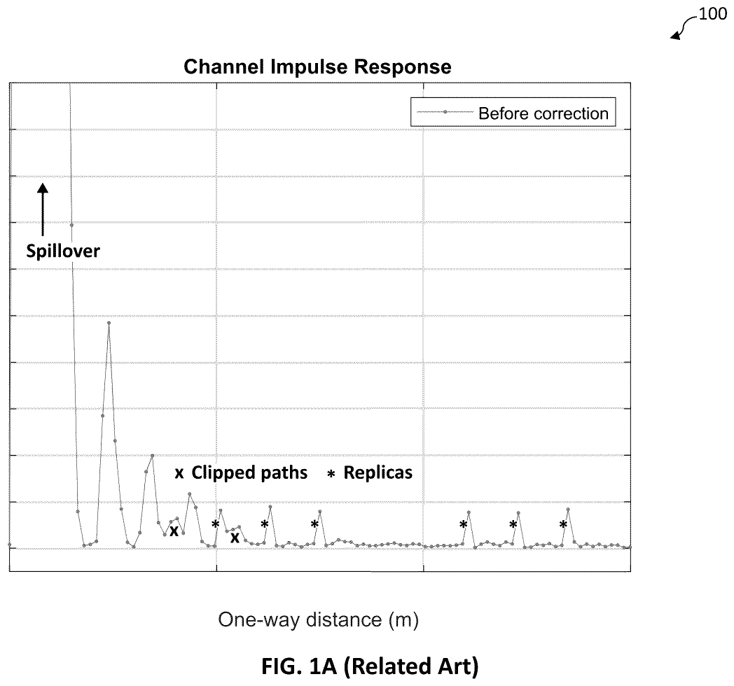

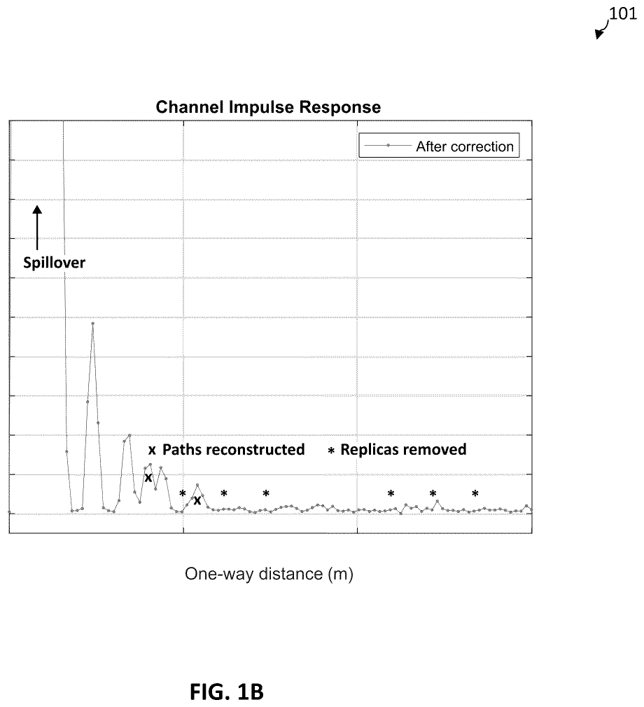

FIG. 1A shows an example of a corrupted CIR estimate 100 with clipped paths and replicas, caused by a shadowing effect by a spillover signal in related art. The receiver may receive RX signals (e.g., pulses corresponding to the TX signal after multi-path propagation). As shown in FIG. 1A, the spillover signal can have an undesirably high magnitude, causing a clipped path and replicas in corrupted CIR estimate, which may make it more difficult to identify all the channel paths, causing inaccuracy in determining a target's position.

Embodiments of the present disclosure involve post-processing the corrupted accumulation of CIR estimate to reconstruct the clipped paths and remove the replicas. FIG. 1B shows the corrected CIR estimate accumulated from the same RX signal after applying the correction method disclosed in this disclosure. It can be shown that now all channel paths are more clearly identifiable, with the clipped path reconstructed and replicas removed. The disclosed method may create a cleaner accumulator for subsequent channel analysis.

Embodiments of the present disclosure describe a novel system and method for generating a corrected channel impulse response (CIR) estimate that with reduced clipped paths and replicas. The channel paths are easier to identify, and a target's position can be determined more accurately and more easily by post-processing detection methods. To generate the corrected CIR estimate, the receiver may determine a correction matrix, which predicts/reflects the shadowing effect caused by the corruption/spillover signal. The correction matrix may be composed based on the sequence and a corruption matrix, which is predetermined based on the predicted corruption of the RX signal. To obtain a unique solution, the receiver may then compute an actual correction matrix from the correction matrix, and compute a corrected CIR estimate based on the corrupted CIR estimate and the actual correction matrix. To determine the actual correction matrix, the receiver may determine a number of columns (and/or rank) of the correction matrix, and determine a reduced correction matrix from the correction matrix based on the number of columns. The receiver may then perform a pseudo-inversion of the reduced correction matrix as the actual correction matrix. The corrupted CIR estimate may be in the form of a matrix containing columns of filtered samples of the corrupted CIR estimate. The columns are divisions of the corrupted CIR estimate based on the grid interval of the transmitted pulse signals (or that of the correlation filter). Each column of filtered samples is delayed by the grid interval from the immediate previous column of filtered samples.

The present disclosure provides methods to improve the CIR estimate for a linear UWB channel, of which the CIR estimate is a linear superposition of a UWB signal after different delays caused by reflections, diffractions, deflections, etc., that sum linearly in the UWB channel. If the original (e.g., measured) CIR estimate is corrupted by a shadowing effect, the disclosed method can be used to remove sidelobes and reconstruct primary/main lobes. A novel correction matrix is disclosed to correct the shadowing effect/corruption in the measured CIR estimate, and a method to find the unique solution using the correction matrix is disclosed. The operations are performed in the accumulator of a receiver of a mono-static radar. In various embodiments, the method can be used with any suitable sequence, e.g., sequence with perfect or non-perfect autocorrelation because the sidelobes due to non-perfect autocorrelation can be corrected in the same way as the sidelobes due to shadowing. For ease of illustration, the embodiments of the present disclosure are described in view of a perfect ternary sequence, e.g., an Ipatov sequence.

In this disclosure, the correction matrix is computed based on prior knowledge (or prediction) of the shadowing effect. The correction matrix and its related parameters (e.g., reduced correction matrix, actual correction matrix, partial correction matrices, etc.) may be computed and/or stored prior to the processing of the RX signal, and may be accessible to the accumulator during operation. The methods thus do not increase the computation load of the receiver when determining the raw CIR estimate, and the computation load may be desirably low for the receiver when determining the corrected CIR estimate.

The present disclosure provides a method to correct the shadowing effects in CIR estimates. The method resolves the UWB channel as a linear combination of attenuated and delayed symbols. A smaller portion of the UWB channel must be selected, and the resulting overdetermined linear system is resolved in the least-squares sense.

In some examples, a sampling rate of 8 times the pulse rate is used. For this reason, the correction involves 16 independent matrix multiplications, 8 for each in-phase and quadrature CIR component.

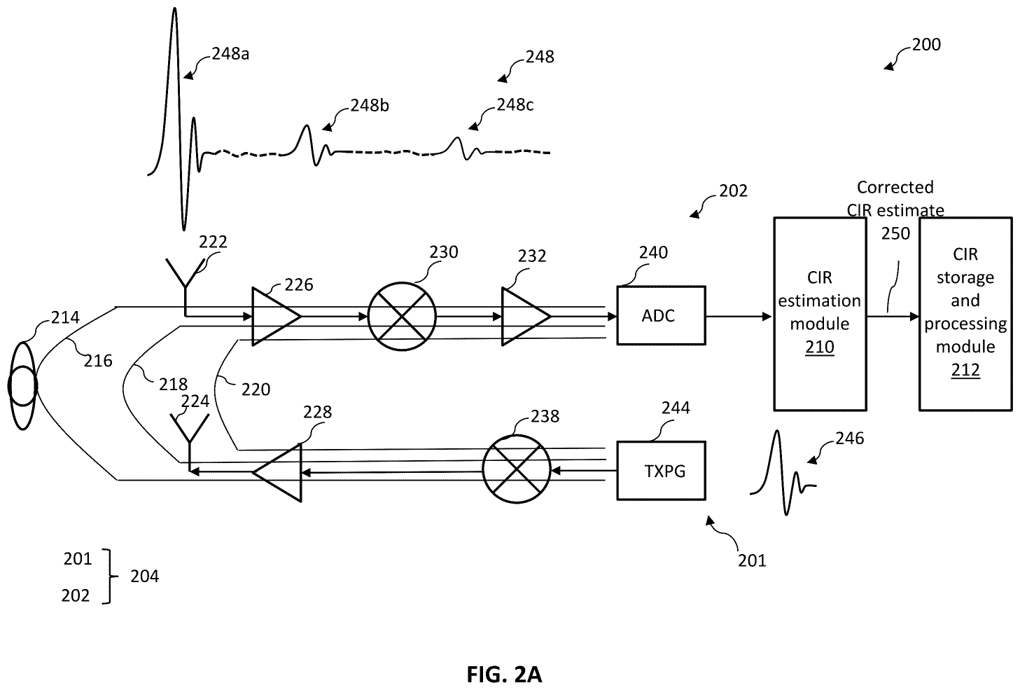

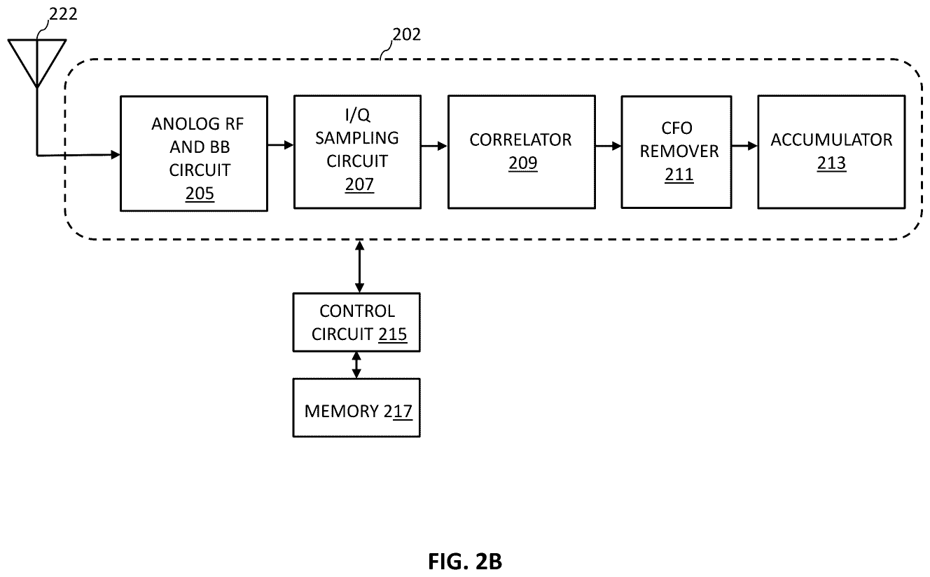

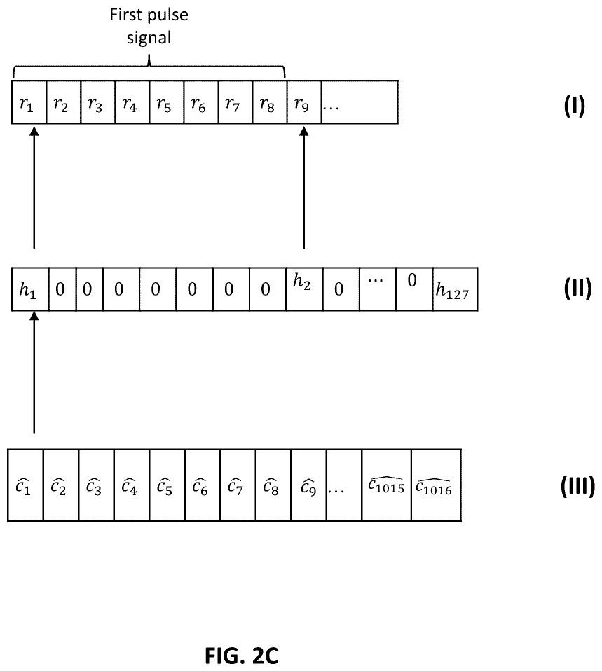

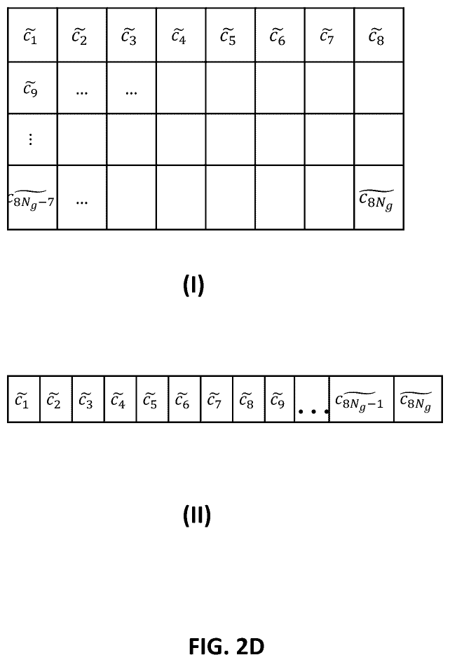

FIG. 2A illustrates a simplified block diagram of a radio frequency (RF) communication system 200, according to some embodiments of the present disclosure. RF communication system 200 may be an example of a mono-static radar (such as a UWB transceiver), and may be configured for sensing applications, such as the detection of the position of a target 214. RF communication system 200 may include a RX/TX module 204 that includes a transmitter 201 and a receiver 202. Receiver 202 may include a CIR estimate estimation module 210 and a CIR estimate storage and processing module 212 for determining a corrected CIR estimate and the post-processing of the corrected CIR estimate. It should be noted that, FIG. 2A is merely a simplified block diagram, and may include additional components not shown in the figure.

The RX/TX module 204 may be configured to transmit a first RF signal 246 and receive a second RF signal 148. In some embodiments, first RF signal 246 may include a first UWB signal, and second RF signal 248 may include a second UWB signal containing signals formed by a multi-propagation of the first UWB signal. For example, second RF signal 248 may be formed by the multi-path propagation of first RF signal 246 that encounters direct transmission, reflections, diffractions, and/or deflections in the environment. First RF signal 246 may take multiple paths of varying lengths to reach back to the RX/TX module 204, forming second RF signal 248. For example, first RF signal 246 may include a plurality of first UWB pulse signals, and second RF signal May include a plurality of second UWB pulse signals corresponding to each one of the first UWB pulse signals.

Transmitter 201 may be configured to transmit first RF signal 246, which may be a signal of a few nanoseconds in the time domain. In some embodiments, first RF signal 216 includes a series of pulse signals (e.g., UWB pulse signals) corresponding to a ternary sequence of chips. For example, first RF signal 216 may include one or more pulse signals corresponding to the non-zero values of the ternary sequence. In some embodiments, the ternary sequence has perfect autocorrection. Transmitter 201 may include a transmitter antenna 224, an amplifier 228, a mixer 238, a transmit power gain (TXPG) module 244. Amplifier 228 may be electrically coupled to transmitter antenna 224 and mixer 238, which may further be electrically coupled to TXPG module 244. TXPG module 244 may be configured to apply a gain or amplification on first RF signal 246. Mixer 238 may be configured to mix the output of TXPG module 244 with a carrier signal. The mixing process may also be referred to as an up-conversion. The output of the mixer 238, e.g., a first mixed signal including the baseband signal and the carrier signal, may then go through amplifier 228, e.g., a power amplifier, which amplifies the first mixed signal. For example, transmitter 201 may include a TX control module (not shown) that controls the transmission power of the amplified first mixed signal. Transmitter antenna 224 may then transmit the amplified first mixed signal. The amplified first mixed signal may undergo multipath propagation and be received by the RX/TX module 204 as second RF signal 248.

Receiver 202 may be configured to receive and process second RF signal 248, which may include a series of pulse signals (e.g., UWB pulse signals), each including one or more paths or taps corresponding to a respective pulse signal in first RF signal 246. As an example shown in FIG. 2A, second RF signal 248 may include a pulse signal that is formed by the transmission of a pulse sequence signal in first RF signal 246, and has paths/taps 248a, 248b, and 248c. The receiver may include a receiver antenna 222, amplifiers 226 and 232, a mixer 230, an analog-to-digital converter (ADC) 240, CIR estimate estimation module 210, and CIR estimate storage and processing module 212. Receiver antenna 222 may be electrically coupled to amplifier 226, which is further electrically coupled to mixer 230. Amplifier 232 may be electrically coupled to mixer 230 and ADC 240, which is further electrically coupled to CIR estimation module 210. CIR storage and processing module 212 is electrically coupled to CIR estimation module 210. Receiver antenna 222 may first receive second RF signal 248. Amplifier 226 may amplify second RF signal 218. Mixer 130 may mix second RF signal 248 with a local oscillator (LO) signal, resulting a second mixed signal that contains both the sum and difference frequencies. The LO signal may shift second RF signal 248 down to a lower intermediate frequency or directly to the baseband. The mixing may also be referred to as a down-conversion. The second mixed signal may then be amplified by amplifier 232 (e.g., a power amplifier), and may further be converted to digital signals by ADC 240. The digital signals may be used by CIR estimate estimation module 210 to generate a corrected CIR estimate 250, which may further be stored and/or processed by CIR estimate storage and processing module 212.

As shown in FIG. 2A, the amplified first mixed signal transmitted from transmitter antenna 224 may propagate along a path 216 and is reflected to receiver antenna 222 by a target 214, and along a path 218 (e.g., a direct path) and is transmitted directly to receiver antenna 222 without encountering any object. Meanwhile, amplified first mixed signal may leak from amplifier 228 to amplifier 226 along a path 220 (e.g., a leakage path). As a result, the signals received from paths 218 and 220 may contribute to a path/tap 248a of undesirably high power, exceeding the thresholds of ADC 240. The signal received from path 216 may result in a path/tap 248b of a lower power. In an example, the signal received from another path (not shown) may result in a path/tap 248c. Path 248a may cause ADC 240 to saturate, and a CIR estimate generated based on second RF signal 248 may have a spillover signal (resulting from path 248a and clipped by the saturation of ADC 240), which may have a shadowing effect on paths 248b and 248c, and affect the post-processing of second RF signal 248. As a result, the location of the target may not be accurately determined.

For example, considering the clipped spillover signal at delay=0, other paths received at delay=0 may then be completely shadowed and, therefore, lost. Paths received between the clipped spillover signals are visible and not shadowed. For example, an Ipatov sequence (an example of the ternary sequence) has a length of N=127, and has Nₚ=64 pulse signals (1 or 1̅) and 63 zeros, 1̅ representing −1. On average, a delayed signal has 50% of the pulse signals shadowed and 50% not. Therefore, on average, it is expected that 32 pulse signals of an Ipatov sequence are not shadowed and still visible. Which pulse signals are shadowed and which are not, may depend on the delay of the signal and the distribution of the zeros in the original Ipatov sequence. By cancelling part of the pulse signals, shadowing modifies the original Ipatov sequence. The resulted shadowed sequence does not have perfect autocorrelation. This generates a corrected CIR estimate that has sidelobes/replicas that occur at locations and with amplitudes that depend on the sequence transmitted and the delay of the received path, referring back to the description of FIG. 1A.

CIR estimation module 210 may be configured to receive second RF signal 248, e.g., a RF signal containing high-magnitude spillover signals caused by a leakage path and/or a direct path, and generate a corrupted CIR estimate affected by a shadowing effect of the spillover signal. CIR estimation module 210 may then generate a corrected CIR estimate 250 for the corrupted CIR estimate, based on the corrupted CIR estimate and a correction matrix L. Corrected CIR estimate 250 may then be further processed or stored for other applications by CIR storage and processing module 212. The process of generating corrected CIR estimate 250 is described as follows.

FIG. 2B shows a simplified block diagram of a receiver 202, according to some embodiments of the present disclosure. Receiver 202 may include an analog and radio frequency (RF) and baseband (BB) processing circuit 205 that takes the received second RF signal 248 and provides front-end processing (e.g., amplification, filtering, down-conversion to a BB frequency) and passes a BB signal to an in-phase/quadrature (I/Q) sampling circuit 207. A sampled second RF signal may be transmitted to a correlator 209. Correlator 209 may correlate the sampled second RF signal with an ideal first RF signal, and may store the correlation signals in memory 217. After the cross-correlation, the correlation signals are transmitted to a carrier frequency offset (CFO) remover 211 that removes the CFO in the correlated signals. The signals after the CFO removal are then transmitted to an accumulator 213 to be accumulated. A corrupted CIR estimate corresponding to a pulse signal can be generated by accumulator 213, and may be stored/cached in memory 217 for generating a corrected CIR estimate. Accumulator 213 may access memory 217 to obtain a prestored correction matrix or an actual correction matrix, and may generate the corrected CIR estimate based on the actual correction matrix and the corrupted CIR estimate. In some embodiments, a control circuit 215 may control the operations of generating the corrupted CIR estimate, retrieving the prestored correction matrix (or actual correction matrix), computing the corrected CIR estimate, etc.

Receiver 202 may include one or more general-purpose processors and/or one or more special-purpose processors (such as digital signal processing chips, graphics acceleration processors, microcontrollers, and/or the like) to perform the functions and operations of control circuit 215, analog RF and BB circuit 205, I/Q sampling circuit 207, correlator 209, CFO remover 211, and accumulator 213. The processor(s) may process the RF signals (e.g., second RF signal 248) received by receiver antenna 222, and output the corrupted CIR estimate for further processing such as correction. Memory 217 may include one or more non-transitory storage devices that can include local and/or network accessible storage, a disk drive, a drive array, an optical storage device, a solid-state storage device such as a random access memory (“RAM”) and/or a read-only memory (“ROM”), a programmable ROM, a flash-updateable ROM, and/or the like. Such storage devices may be configured to implement any appropriate data storage, including without limitation, various file systems, algorithms, corrupted CIR estimates, correction matrix and/or actual correction matrix, corrected CIR estimate, other matrices for the computing of the corrected CIR estimate, and/or the like.

In various embodiments, functions/operations may be stored as one or more instructions or code in memory 217, such as on a computer-readable storage medium, such as RAM, ROM, FLASH, or disc drive, and executed by the processor(s). Memory 217 may also be stored with software components including, for example, an operating system, device drivers, executable libraries, and/or other executable code, such as one or more application programs. The application programs may include computer programs, stored in memory 217, executed by the processor(s) to implement various functions under the control of the operating system. In some embodiments, the processor(s) may also be configured to control the operations of transmitter 201 and receiver 202. In an example, the processor(s) may be shared by receiver 202 and the transmitter 201.

The processor(s) (e.g., accumulator 213, part of CIR estimation module 210) may compute a correction matrix L used for correcting a corrupted CIR estimate. In some embodiments, an actual correction matrix

$${L}_{R}^{†}$$

is computed from correction matrix L for the correction operation. Correction matrix L, actual correction matrix

$${L}_{R}^{†} ,$$

and any other parameters/matrices used for the correction operation may be predetermined and prestored for the correction operation (e.g., prior to the reception of second RF signal 248), and/or determined after the reception of second RF signal 248. The operations to determine correction matrix L are described as follows.

First, accumulator 213 may determine a correction-element matrix H based on the ternary sequence h to be transmitted by transmitter 201. Correction-element matrix H may be a Toeplitz matrix composed from h, with rows being shifted/delayed copies of h. It is assumed that h has a length of N chips, and has a number of Nₚ pulse signals (e.g., non-zero elements). For example, for an Ipatov sequence, N is equal to 127, and Nₚ is equal to 64. Each row of correction-element matrix H is shifted by one row element compared to the immediate previous row. For example, ternary sequence is represented by h=[1 0 1̅ 1 1̅ . . . 0 1̅], where 1̅=−1. The periodic autocorrelation vector with a matrix-vector multiplication can be computed as

$$C = H \cdot {h}^{T} \qquad ( 1 )$$

Correction-element matrix H may be a Toeplitz matrix and may be determined to be:

$$H = toeplitz ( h ) = [ \begin{matrix}circshift ( h , 0 ) \\ circshift ( h , 1 ) \\ ⋮ \\ circshift ( h , N - 1 )\end{matrix} ] \qquad ( 2 )$$

In equation (2), “circshift(h, K)” refers to the operation of shifting the elements in ternary sequence h=[1 0 1̅ 1 1̅ . . . 0 1̅] by K positions. For example, ternary sequence (e.g., an Ipatov sequence) is represented by h=[1 0 1̅ 1 1̅ . . . 0 1̅], where 1̅=−1. The corresponding correction-element matrix H matrix may be

$$[ \begin{matrix}10 \overline{1} & … & 0 \overline{1} \\ \overline{1} 10 & … & ⋮ \\ ⋮ & ⋱ & ⋮ \\ 0 \overline{1} & … & \overline{1} 1\end{matrix} ] .$$

Next, accumulator 213 may determine a correction matrix L based on correction-element matrix H. Correction matrix L may be used as the base to compute the corrected CIR estimates for pulse signals in the corresponding ternary sequence. In some embodiments, correction matrix L is also referred to as Lobe codes, which represents the sequence of lobes obtained after correlating the ideal ternary sequence with the corrupted ternary sequence (e.g., received in second RF signal 248). Correction matrix L predicts the shadowing in second RF signal 248. Correction matrix L is computed as:

$$L = H \cdot D \cdot {H}^{T} \qquad ( 3 )$$

In equation (3), corruption matrix D represents the distortion to taps/paths caused by shadowing, and can be modeled as a mask applied to the incoming signal (e.g., first RF signal 246). The mask may result in ones when the pulses can pass and zeros if shadowed. After distortion, the received signal \hat{r} (e.g., second RF signal 248) may be modeled as:

$$\hat{r} = D \cdot r = D \cdot {H}^{T} \cdot c \qquad ( 4 )$$

In equation (4), corruption matrix D is an identity matrix with some diagonal elements set to zero where the signal is removed by shadowing, and c may be an ideal CIR estimate (without any distortion such as spillover signals). It may be assumed that the diagonal elements of corruption matrix D is the complementary of the absolute values of ternary sequence h: D=diag(1−abs(h)), based on the assumption that non-zero pulses are shadowed and zeros pass. In an example, for ternary sequence h=[1 0 1̅ 1 1̅ . . . 0 1̅], D=diag ([0 1 0 0 0 . . . 1 0]).

The corrupted CIR estimate ĉ (e.g., an observed CIR) may then be modeled as:

$$\hat{c} = H \cdot \hat{r} = H \cdot D \cdot {H}^{T} \cdot c = L \cdot c \qquad ( 5 )$$

In equation (5), L=H·D·H^{T} is symmetric. The ideal CIR estimate, c, may indicate the lobe codes that are summed together to give the CIR observed, ĉ (e.g., the corrupted CIR estimate corresponding to a pulse signal in first RF signal 246). Without shadowing, D=I_{N}, and L=H·H^{T}=NₚI_{N}, are as expected.

Thus, as shown in equation (3), correction matrix L may be dependent only on the ternary sequence (e.g., Ipatov sequence) and does not change with circular shifting or sign inversion. In some embodiments, code flipping, e.g., reversing the order of elements, may change it because the codes are not symmetric.

In an example, for h=[1 0 1̅ 1 1̅ . . . 0 1̅], the correction matrix L may be determined as:

$$L = H \cdot D \cdot {H}^{T} = ( \begin{matrix}{l}_{0} & {l}_{1} & … & {l}_{N - 1}\end{matrix} ) = ( \begin{matrix}0 & 0 & … & 0 \\ 0 & 32 & … & - 4 \\ ⋮ & ⋮ & ⋱ & ⋮ \\ 0 & - 4 & … & 32\end{matrix} ) ,$$

with each column of correction matrix L being a delayed path of the immediate previous path. It may be assumed that h is an Ipatov sequence (N=127, Nₚ=64 pulse signals (1 or 1̅) and 63 zeros), and on average, a delayed signal has 50% of the pulses shadowed and 50% not shadowed. The diagonal elements of correction matrix L may represent the main lobe of 32 pulses not shadowed, and the non-diagonal elements may represent the sidelobes. For example, for a delay=2 the lobe code could look like: l₂=(0 −4 32 . . . 4 0)^{T}.

The ideal CIR estimate c can be estimated from equation (5) by inversion of matrix L. However, because correction matrix L is not full rank (e.g., all rows and columns are linearly independent), there are infinitely many solutions. A meaningful unique solution can be obtained if a reduced number of columns of correction matrix L is considered. In other words, the disclosed method may express the complete CIR estimate by using a linear combination of fewer paths and their secondary lobes.

A reduced correction matrix may be defined as L_{R}=L(:, 1: N_{g})=·D·H(1: N_{g}, :)^{T}, where N_{g} is the number of grid taps considered.

In this disclosure, the columns of correction matrix L represent paths at different delays, the columns may be selected where there is a “reason to believe” that a path is present at that delay. In various embodiments, methods that can be used to select the N_{g} columns/rows may include but are not limited to: analysis of previous sensing frames, energy detection, taps that cross a given threshold, combination of columns that minimizes a certain cost function after correction, knowledge of the final application (for example, if it is known that the signal travels in a wire for the first 2 meters, no reflection is expected within the 2 meters, hence no reason to select the corresponding columns of correction matrix L). In some embodiments, it may not be required for the selected columns to be consecutive and form a unique block. However, without any previous knowledge, it may be reasonable to assume that the reflections are in the first part of the channel (from 1 to N_{g}) because reflections from objects further aways fade out with the inverse of the distance⁴ according to the radar equation. In some embodiments, one method to select N_{g} may be to start with a larger number (for example N_{g}=25, corresponding to 30 m), and reduce it later on if no paths are detected after a certain distance (e.g., x meters).

In some embodiments, the grid positions containing channel paths are the first N_{g} (e.g., corresponding to the first N_{g} columns of correction matrix L) after the pulse signals (e.g., first RF signal 246) are transmitted. This assumption is often the case in sensing applications because the signal magnitude decreases with the 4^{th} power of the distance of the reflecting object (radar equation). For example, N_{g}=25 corresponds to an unambiguous reflected channel distance of approximately 30 m.

A pseudo-inversion of L_{R}, noted as

$${L}_{R}^{†}$$

may be computed to compute the corrected CIR estimate \tilde{c}, which is the unique solution to equation (5) and is the estimate of the first N_{g} columns of ideal CIR estimate c. Using

$${L}_{R}^{†} ,$$

the least-squares solution may be obtained:

$$\tilde{c} = {( {L}_{R}^{T} {L}_{R} )}^{- 1} {L}_{R}^{T} \cdot \hat{c} = {L}_{R}^{†} \cdot \hat{c} \qquad ( 6 )$$

where

$${L}_{R}^{†} = {( {L}_{R}^{T} {L}_{R} )}^{- 1} {L}_{R}^{T}$$

is the Moore-Penrose inverse of matrix L_{R}.

N_{g} may determine the dimension of the matrix to be inverted or stored and the number of multiplications required for correction. In some embodiments, N_{g} may be sufficiently large to include any paths of the real channel because it is assumed that c=0 after less than N_{g} elements.

To compute

$${L}_{R}^{†} = {( {L}_{R}^{T} {L}_{R} )}^{- 1} {L}_{R}^{T} ,$$

accumulator 213 may compute: H_{R}=H(1: N_{g}, :); H_{S}=H(N_{g}+1: N, :); therefore,

$$H = {[ {H}_{R}^{T} , {H}_{S}^{T} ]}^{T} ; and$$

$${L}_{RR} = L ( 1 : {N}_{g} , 1 : {N}_{g} ) = {H}_{R} \cdot D \cdot {H}_{R}^{T} ; \\ {L}_{SR} = L ( {N}_{g} + 1 : N , 1 : {N}_{g} ) = {H}_{S} \cdot D \cdot {H}_{R}^{T} ,$$

therefore

$${L}_{R} = {[ {L}_{RR}^{T} , {L}_{SR}^{T} ]}^{T} .$$

Then, accumulator 213 may compute

$${L}_{R}^{†}$$

to be:

$${L}_{R}^{†} = {( {L}_{R}^{T} {L}_{R} )}^{- 1} {L}_{R}^{T} = {( {H}_{R} \cdot {D}^{T} \cdot {H}^{T} \cdot H \cdot D \cdot {H}_{R}^{T} )}^{- 1} {L}_{R}^{T} = {( {H}_{R} \cdot D \cdot {H}_{R}^{T} )}^{- 1} {L}_{R}^{T} = {L}_{RR}^{- 1} \cdot {L}_{R}^{T} \qquad ( 7 )$$

where H^{T}·H=I_{N} and D^{T}·D=D, because corruption matrix D is a diagonal matrix with non-zero entries equal to 1. Matrix L_{R} can be split into L_{RR} and L_{SR}:

$${L}_{R}^{†} = {L}_{RR}^{- 1} \cdot [ {L}_{RR}^{T} , {L}_{SR}^{T} ] = [ {I}_{R} , {L}_{RR}^{- 1} \cdot {L}_{SR}^{T} ] \qquad ( 8 )$$

$$where {L}_{RR}^{- 1} \cdot {L}_{RR}^{T} = {L}_{RR}^{- 1} \cdot {L}_{RR} = {I}_{R}$$

because L_{RR} is symmetric. Equation (8) involves the inversion of the smaller N_{g}×N_{g} matrix, L_{RR}. In the present disclosure, L_{RR} may be referred to as a first block correction matrix, and L_{SR} may be referred to as a second block correction matrix.

Thus, the disclosed method, e.g., a replica cancellation method may include computing or storing of

$${L}_{RR}^{- 1} \cdot {L}_{SR}^{T} .$$

In some embodiments,

$${L}_{RR}^{- 1} \cdot {L}_{SR}^{T}$$

may be computed once for a specific ternary sequence and stored prior to the correction of the corrupted CIR estimate. The accumulator 213 may then compute a corrected CIR estimate 250 for each pulse signal in a ternary sequence. For example, for an Ipatov sequence, 64 corrected CIR estimates may be computed for the 64 non-zero pulse signals.

Accumulator 213 may determine

$${\hat{c}}_{R}^{T} and {\hat{c}}_{S}^{T}$$

based on ĉ. In some embodiments,

$${\hat{c}}_{R} = \hat{c} ( 1 : {N}_{{g}^{′}} : ) ; {\hat{c}}_{S} = \hat{c} ( {N}_{g} + 1 : N , : ) ; \hat{c} = {[ {\hat{c}}_{R}^{T} , {\hat{c}}_{s}^{T} ]}^{T} .$$

For each UWB signal received by receiver 202, a corrected CIR estimate \tilde{c} may be computed as:

$$\tilde{c} = {\hat{c}}_{R} + ( {L}_{R R}^{- 1} \cdot {L}_{S R}^{T} ) \cdot {\hat{c}}_{S} , where \hat{c} = {[ {\hat{c}}_{R}^{T} , {\hat{c}}_{S}^{T} ]}^{T} \qquad ( 9 )$$

Accumulator 213 may determine corrupted CIR estimate ĉ for the computation of corrected CIR estimate \tilde{c}, using equation (6). FIG. 2C shows the processing of the received signal (e.g., second RF signal 248) to obtain corrupted CIR estimate ĉ, according to some embodiments. It should be noted that corrected CIR estimate, corrected CIR estimate \tilde{c}, and ideal CIR estimate c are complexed valued.

Received RF signal 248 may be sampled by receiver 202 (e.g., by I/Q sampling circuit 207). It is assumed that the pulse signals of the ternary sequence are transmitted at an interval of M nsec (e.g., by transmitter 201), and the sampling interval is Ns nsec (Ns<M), then in each of the M interval, M/Ns samples may be obtained, and a total of M×J/Ns samples may be obtained for a ternary sequence of J chips. For example, as shown in FIG. 2C (I), first RF signal 246 may be an Ipatov sequence h=[h₁, h₂, . . . , h₁₂₇], where hᵢ (i=1, 2, . . . , 127) may be equal to 1, −1, or 0. First RF signal 246 may include zero and non-zero pulse signals corresponding to h, and may be transmitted by transmitter 201 at an interval of approximately 8 nsec (e.g., each pulse signal may be transmitted 8.0128 nsec after the previous pulse signal). The sampling rate by receiver 202 is approximately 1 GHz (e.g., 998.4 MHZ), such that the samples may come as a stream of approximately 1 GHz (e.g., a sample each 1.0016 nsec). Then each pulse signal may be sampled to include 8 samples received by receiver 202. As an example, second RF signal 248 may be an example of received pulse signals corresponding to the Ipatov sequence. For example, paths 248a, 248b, or 248c) and may be sampled to generate 8 samples r₁, . . . , r₈, . . . , so on and so forth. For example, 1016 (e.g., (M/Ns)×N=8/1×127) samples may be generated for the Ipatov sequence.

Correlator 209 may apply a correlation filter (e.g., a finite impulse response (FIR) filter) that perform cross-correlation of second RF signal 248 by applying correlation coefficients on the samples. In some embodiments, the samples corresponding to each pulse signal then may be cross-correlated with the chip value of itself in first RF signal 246. For example, as shown in FIG. 2C (II) and (III), the samples (r₁, . . . , r₈) corresponding to the first pulse signal in first RF signal 246 may be cross-correlated with h₁, the samples (r₉, . . . , r₁₆) corresponding to the second pulse signal in first RF signal 246 may be cross-correlated with h₂, . . . , and the samples corresponding to the 127^{th} pulse signal may be cross-correlated with h₁₂₇. The corrupted CIR estimate ĉ may be obtained as:

$$= {h}_{1} {r}_{1} + {h}_{2} {r}_{9} + ⋯ {h}_{127} {r}_{1009} \\ = {h}_{1} {r}_{2} + {h}_{2} {r}_{10} + ⋯ {h}_{127} {r}_{1010} \\ … … \\ = {h}_{1} {r}_{8} + {h}_{2} {r}_{16} + ⋯ {h}_{127} {r}_{1016} \qquad ( 10 )$$

Corrupted CIR estimate ĉ may be the output of a polyphase filter, where

$$[ , , … ]$$

may be computed based on

$$[ {r}_{1} , {r}_{\frac{M}{Ns} + 1} , {r}_{\frac{2 M}{Ns} + 1} , … ] ( phase 1 ) , \\ [ , … ]$$

may be computed based on

$$[ {r}_{2} , {r}_{\frac{M}{Ns} + 2} , {r}_{\frac{2 M}{Ns} + 2} , … ]$$

(phase 2), and so on up to phase M/Ns. In other words, the samples of corrected CIR estimates ĉ corresponding to the ternary sequence may be grouped to compose a matrix for the computation based on their respective pulse signals and the positions in the ternary sequence. For an Ipatov sequence, [ [symbol] . . . ] may be computed based on [r₁, r₉, r₁₇, . . . ] (phase 1), [ [symbol] [symbol] . . . ] may be computed based on [r₂, r₁₀, r₁₈, . . . ] (phase 2), and so on up to phase 8. In other words, in this disclosure, the analysis done on the impulses, is also valid for the pulses if the M/Ns (e.g., 8) phases are considered independently.

In the matrix form, corrupted CIR estimate ĉ may be expressed as:

$$( \begin{matrix} & ⋯ & \\ & ⋱ & ⋮ \\ ⋮ & ⋯ & \end{matrix} ) .$$

Thus, samples corresponding to each pulse signal in first RF signal 246 may form a respective row of corrupted CIR estimate ĉ, and samples of the same position of pulse signal mays form respective columns. Thus, equation (5) may be expressed as:

$$( \begin{matrix}{L}_{11} & ⋯ & {L}_{1 {N}_{g}} \\ ⋮ & ⋱ & ⋮ \\ {L}_{N 1} & ⋯ & {L}_{NNg}\end{matrix} ) \cdot ( \begin{matrix}{c}_{11} & ⋯ & {c}_{81} \\ ⋮ & ⋱ & ⋮ \\ {c}_{1 {N}_{g}} & ⋯ & {c}_{8 Ng}\end{matrix} ) = ( \begin{matrix} & ⋯ & \\ & ⋱ & ⋮ \\ ⋮ & ⋯ & \end{matrix} ) \qquad ( 11 )$$

As shown in equation (11), samples corresponding to each pulse signal may form a respective row of corrupted CIR estimate ĉ, and samples of the same position of pulse signals may form a respective column. Equation (11) may be solved by computing

$${L}_{R R}^{- 1} \cdot {L}_{S R}^{T} , {\hat{c}}_{R}^{T} and {\hat{c}}_{S}^{T} .$$

After solving equation (11), a corrected CIR matrix \tilde{c} may be obtained using the least-squares solution as shown in equations (6) and (9). For example, a

$${N}_{g} \times \frac{M}{Ns}$$

matrix of \tilde{c} may be obtained and later rearranged to a sequence of

$$\frac{M}{Ns} {N}_{g}$$

corrected CIR values. For an Ipatov sequence, a corrected CIR matrix \tilde{c} may be obtained in FIG. 2D (I), and may be rearranged/reshaped to (II), e.g., for post-processing.

In some embodiments, the correction step of equation (9) can be adapted using a coefficient 0≤K≤1:

$$\tilde{c} = {\hat{c}}_{R} + K ( {L}_{R R}^{- 1} \cdot {L}_{SR}^{T} ) \cdot {\hat{c}}_{S} \qquad ( 12 )$$

In some embodiments, the correction must be applied independently to each sample in the grid interval, that is M/Ns samples (e.g., 8 samples for an 8 nsec grid at 1 GHz). Alternatively or optionally, selective correction could be applied only to samples at M nsec (e.g., 8 nsec) multiples of saturated samples.

The two points above could be implemented together, where (M/Ns)×K coefficients (e.g., 8 K coefficients for 8 times sample rate) are used to select the amount of correction. Each coefficient might be calculated based on the level of saturation of each sample.

In some embodiments, if the channel is not only a linear combination of lobe codes, additional columns may be attached to reduced correction matrix L_{R} to account for other factors. For example, the clock leakage signal could be characterised up to a scaling factor, which is intrinsically derived after the matrix inversion of equation (6).

In some embodiments, reduced correction matrix L_{R} may be obtained assuming that all real paths are contained within the first N_{g} channel taps. However, this is not a requirement, and columns may be selected based on previous knowledge, energy detection, or other methods/criteria. It is also not required for the columns to be consecutive and form a unique block.

The linear system of equation (5) was solved in equation (6) by minimizing the least-squares error. This is equivalent to minimizing the 2-norm ∥L·\tilde{c}−ĉ∥₂. Other norms or other cost functions based on equation (5) may also be minimized to obtain the range profiling solution.

Embodiments of the present disclosure may include various cases where an UWB channel can be modelled as a linear combination of sequences, as per equation (5). For example, the disclosed method may also be applied to remove sidelobes/replicas introduced by CFO, or replicas of codes with non-ideal ambiguity function like those used in the scrambled timestamp sequence (STS) field in a UWB frame. In these cases, replicas are naturally present and are not caused by shadowing.

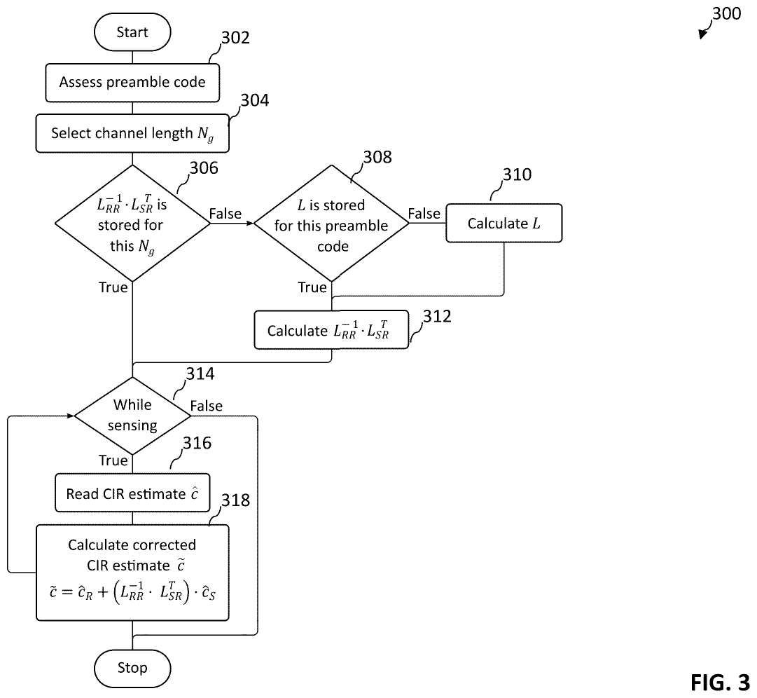

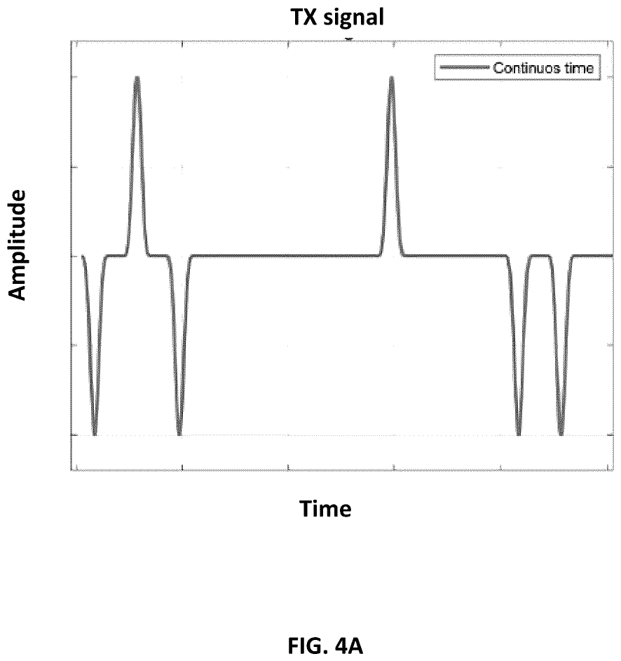

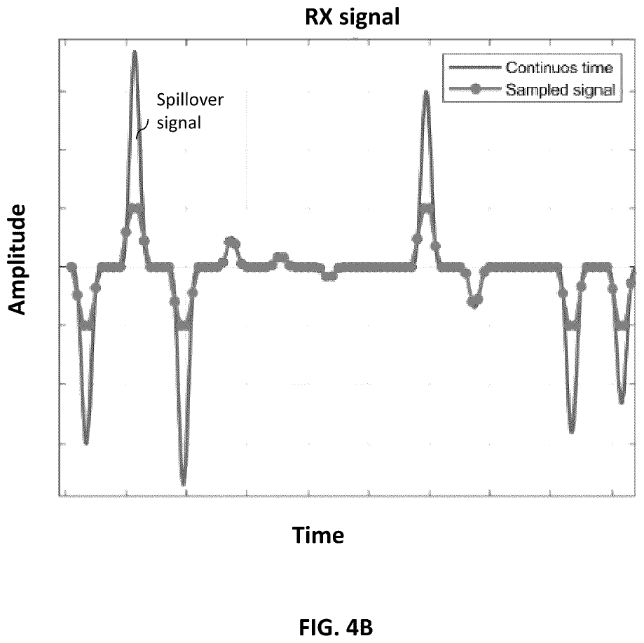

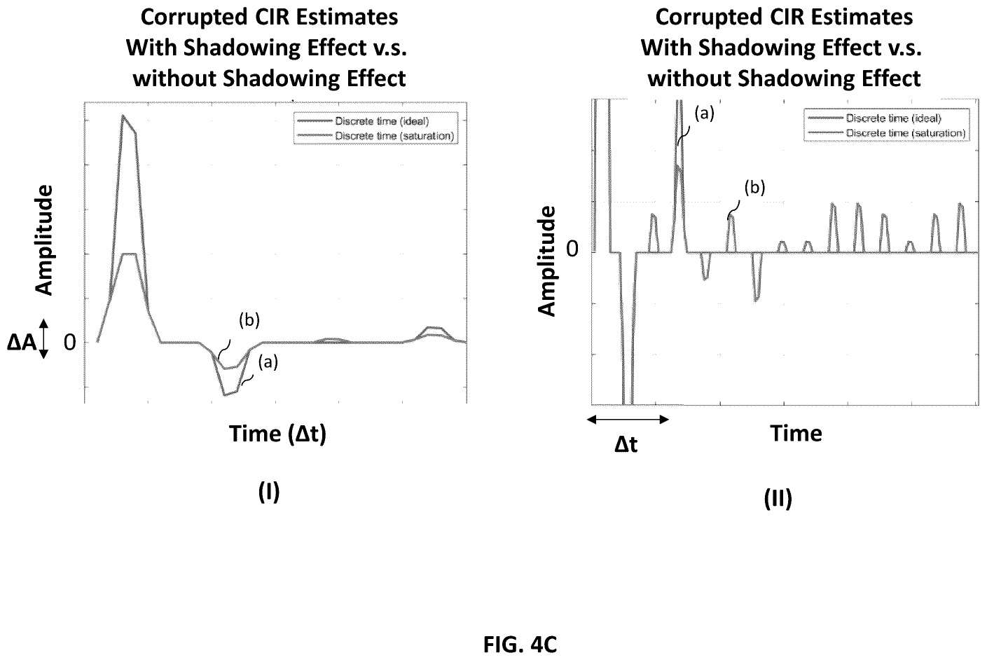

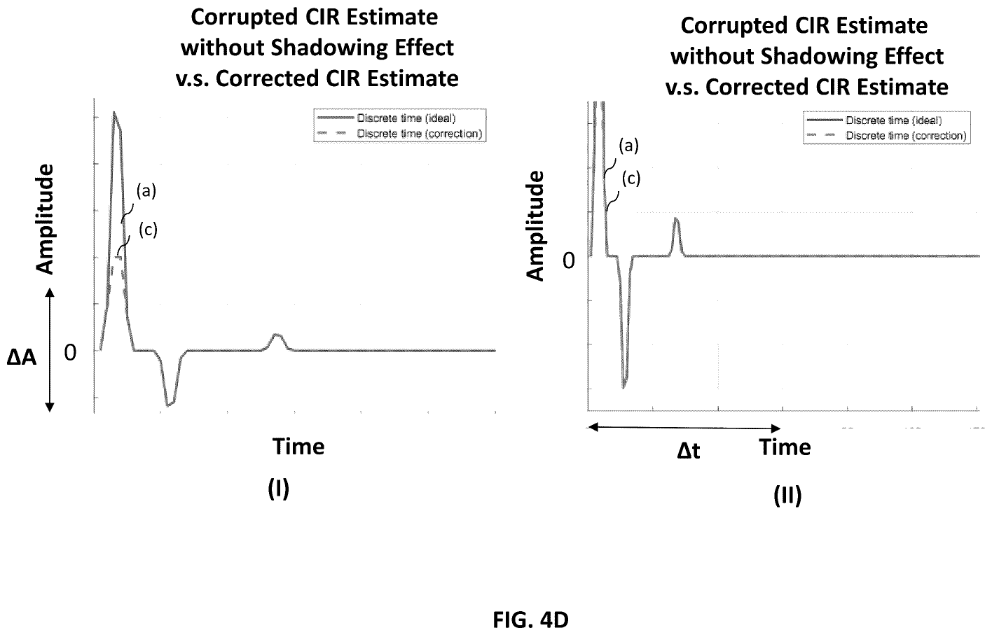

FIG. 3 illustrates a method 300 to implement the disclosed method for generating a corrected CIR estimate. Method 300 may include the operations by receiver 202. For ease of illustration, method 300 may be described in view of FIGS. 4A-4D.

At step 302, receiver 202 may access preamble code. Transmitter 201 may transmit pulse signals corresponding to a ternary sequence (also referred to as a preamble sequence/code), such as an Ipatov sequence, in a preamble field of a UWB frame. The polarity of the pulse signals may be determined by the ternary sequence. For example, the pulse signals are spaced by 8 nsec. In some embodiments, a plurality of repetitions of the preamble code are transmitted. FIG. 3A shows an example of a ternary sequence (“TX signal”) transmitted by transmitter 201. The TX signal may include pulses corresponding to 1, −1, and 0. Receiver 202 may receive corresponding pulse signals (“RX signal”) after the multi-path propagation of the TX signal, as shown in FIG. 4B.

Before being processed by accumulator 213, the RX signal may be sampled and passed through an ADC (e.g., 240 or 207). In some embodiments, the RX signal may include a spillover signal prior to pass the ADC, as shown in the continuous line in FIG. 4B. The spillover signal may cause the ADC to saturate and clip some pulse signals. After passing the ADC, the sampled RX signal may be clipped to have distortion, e.g., losing intensities in some pulse signals due to the saturation of the ADC, as shown in the dotted continuous line in FIG. 4B. The spillover signal may also have a shadowing effect on the pulse signals (e.g., paths) with lower intensities, and can cause the main lobe to be halved and replicas (e.g., side lobes or smaller copies of the main lobe) in the CIR estimate ĉ.

FIG. 4C shows the corrupted CIR estimates with versus without shadowing effect. Plot (a) may be a corrupted CIR estimate without shadowing effect, and plot (b) may be a corrupted CIR estimate with shadowing effect. In some embodiments, it is assumed that the sampled RX signal does not cause an ADC to saturate and thus no shadowing effect occurs. (I) and (II) may be the same figure of different scales. As shown in FIG. 4C, (I) may show a shorter time period (e.g., Δt of (II)), and a larger intensity range, and (II) may show a longer time period and a smaller intensity range (e.g., ΔA of (I)). It can be shown from (I) and (II) that, the shadowing effect causes a halved main lobe and emerging side lobes.

At step 304, receiver 202 may select channel length N_{g}. Receiver 202 may determine the value of N_{g} based on the desired correction length or on the expected location of channel taps, referred back to the description of FIGS. 2A and 2B. In some embodiments, the value of N_{g} may be predetermined and stored in receiver 202 (e.g., in memory 217) for a specific preamble code (e.g., ternary sequence), and may be retrieved for the computation of corrected CIR estimate \tilde{c}.

At step 306, receiver 202 may determine whether

$${L}_{R R}^{- 1} \cdot {L}_{S R}^{T}$$

is stored (e.g., in memory 217) for the N_{g}. If true, method 300 may proceed to step 314, at which receiver 202 may determine whether it is still sensing a target. If false, method 300 may proceed to step 308, at which receiver 202 may determine whether correction matrix L is stored for this preamble code. If true, receiver 202 may proceed to step 312, at which receiver 202 may calculate

$${L}_{R R}^{- 1} \cdot {L}_{S R}^{T}$$

based on correction matrix L. If false, receiver 202 may proceed to step 310, at which receiver 202 may calculate correction matrix L.

At step 314, if receiver 202 determines it is still sensing a target, receiver 202 may proceed to step 316, at which receiver 202 may read/determine corrected CIR estimate ĉ, as described in view of FIGS. 2C and 2D. Receiver 202 may then calculate [symbol] and [symbol] based on ĉ, and determine corrected CIR estimate \tilde{c}, in step 318 referring back to the description of equations (6), (9), and (11). If receiver 202 determines it is no longer sensing any target, receiver 202 may stop the process of method 300.

FIG. 4D shows the corrupted CIR estimate without shadowing effect versus a corrected CIR estimate. Plot (a) may be a corrupted CIR estimate without shadowing effect as shown in FIG. 4C, and plot (c) may be a corrected CIR estimate according to embodiments of the present disclosure. (I) and (II) may be the same figure of different scales. As shown in FIG. 4D, (I) may show a shorter time period (e.g., Δt of (II)), and a larger intensity range, and (II) may show a longer time period and a smaller intensity range (e.g., ΔA of (I)). It can be shown from (I) and (II) that, the corrected CIR estimate may recover the intensity of the main lobe and suppress/eliminate the side lobes caused by the shadowing effect. It is thus easier to determine the position of a target based on the corrected CIR estimate.

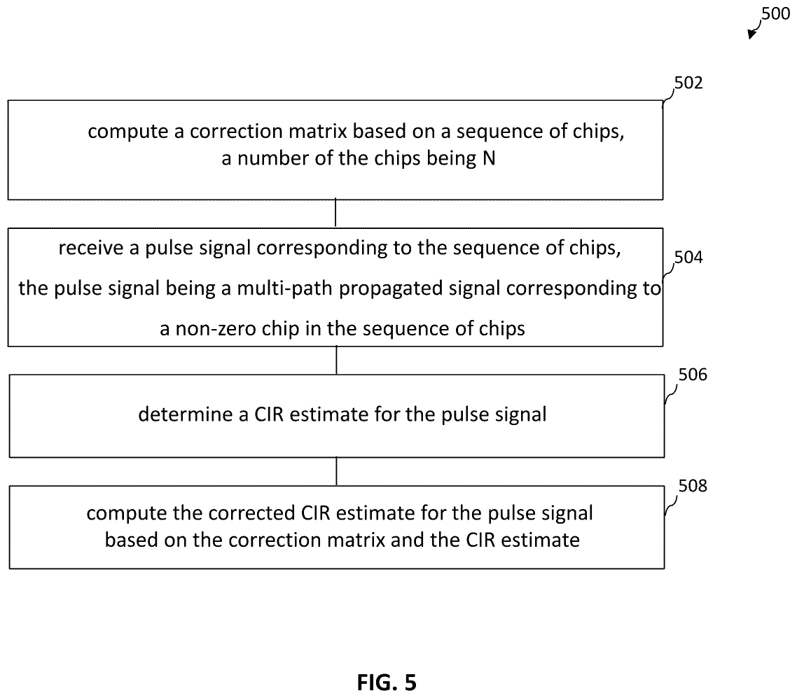

FIG. 5 is a flowchart of a method 500 for generating a corrected CIR estimate by a receiver (e.g., the RX/TX module 204 or receiver 202), according to some embodiments of the present disclosure. Method 500 is merely an example, and is not intended to limit the present disclosure beyond what is explicitly recited in the claims. Additional operations can be provided before, during, and after the method 500, and some operations described can be replaced, eliminated, or moved around for additional embodiments of method 500. For ease of illustration, FIG. 5 is described in connection with FIGS. 2A-2D.

At step 502, a correction matrix is computed based on a sequence (e.g., first RF signal 246) of chips, a number of the chips being N.

At step 504, a pulse signal (e.g., second RF signal 248) corresponding to a second sequence of chips is received, the pulse signal being a multi-path propagated signal (e.g., paths 216, 218, and 220) corresponding to a non-zero chip in the sequence of chips.

At step 506, a CIR estimate (e.g., (III) of FIG. 2C) is determined for the pulse signal.

At step 508, the corrected CIR estimate (e.g., (I) and (II) of FIG. 2D) is computed for the pulse signal based on the correction matrix and the CIR estimate.

Those skilled in the art will recognize improvements and modifications to the preferred embodiments of the present disclosure. All such improvements and modifications are considered within the scope of the concepts disclosed herein and the claims that follow.

What is claimed is:

1. A method for generating a corrected channel impulse response (CIR) estimate by a receiver of a ultra-wideband (UWB) device, comprising:
computing a correction matrix based on a sequence of chips, a number of the chips being N;
receiving a pulse signal corresponding to the sequence of chips, the pulse signal being a multi-path propagated signal corresponding to a non-zero chip in the sequence of chips;
determining a CIR estimate for the pulse signal; and
computing the corrected CIR estimate for the pulse signal based on the correction matrix and the CIR estimate.

2. The method of claim 1, wherein the computing of the correction matrix comprises:
composing a first correction-element matrix to be a Toeplitz matrix of the sequence of chips;
determining a corruption matrix from the sequence of chip, the corruption matrix being a diagonal matrix with diagonal elements being complementary of the sequence of chips;
determining a second correction-element matrix to be a transpose of the first correction-element matrix; and
computing the correction matrix to be a product of the first correction-element matrix, the corruption matrix, and the second correction-element matrix.

3. The method of claim 2, wherein computing of the corrected CIR estimate for the pulse signal based on the correction matrix and the CIR estimate comprises:
determining a number of columns of the correction matrix to be N_{g}, N_{g} being less than or equal to N;
determining a reduced correction matrix to have the N rows of the correction matrix and N_{g} columns of the correction matrix;
determining an actual correction matrix by computing a pseudo-inversion of the reduced correction matrix; and
computing the corrected CIR estimate based on the actual correction matrix and the CIR estimate.

4. The method of claim 3, wherein the computing of the pseudo-inversion of the reduced correction matrix comprises:
determining a first part of the correction matrix to be a first block correction matrix, the first block correction matrix having a N_{g} rows of the correction matrix and a N_{g} columns of the correction matrix;
determining a second part of the correction matrix to be a second block correction matrix, the second block correction matrix having a remaining (N−N_{g}) rows of the correction matrix and the N_{g} columns of the correction matrix; and
computing a second product of an inverted first block correction matrix and a transposed second block correction matrix.

5. The method of claim 4, wherein the determining of the CIR estimate comprises:
sampling the pulse signal to obtain a plurality of samples;
filtering the plurality of samples using a correlation filter;
dividing filtered samples into one or more groups based on a grid interval of the correlation filter, each of the groups having a length of the grid interval; and
composing an initial CIR estimate from the plurality of groups, each of the one or more groups being a respective column of the initial CIR estimate.

6. The method of claim 5, wherein the computing of the corrected CIR estimate comprises:
determining a first part of the initial CIR estimate to be a first partial CIR estimate, the first partial CIR estimate having a N_{g} rows of the initial CIR estimate;
determining a second part of the initial CIR estimate to be a second partial CIR estimate, the second partial CIR estimate having a remaining (N−N_{g}) rows of the initial CIR estimate; and
computing a sum of the first partial CIR estimate and a weighted third product of the second partial CIR estimate and the second product.

7. The method of claim 6, wherein the weight of the third product is greater than or equal to zero, and less than or equal to 1.

8. The method of claim 4, further comprising computing and storing the product of the inverted first block correction matrix and the transposed second block correction matrix prior to the computing of the CIR estimate.

9. The method of claim 1, wherein the sequence of chips comprise a ternary sequence.

10. The method of claim 3, wherein the computing of the corrected CIR estimate based on the actual correction matrix and the CIR estimate comprises obtaining a unique solution of the corrected CIR estimate by minimizing the least-squares error.

11. An ultra-wide band (UWB) device, comprising:
a receiver operable to perform a UWB communication;
a memory for storing program instructions, weight parameters, cipher codes, channel-impulse response (CIR) estimates accumulated from the cipher codes, and matrices for computing the CIR estimates; and
a processor coupled to the receiver and to the memory, wherein the processor is operable to execute the program instructions, which, when executed by the processor, cause the UWB device to perform the following operations:
computing a correction matrix based on a sequence of chips, a number of chips being N;
receiving a pulse signal corresponding to the sequence of chips, the pulse signal being a multi-path propagated signal corresponding to a non-zero chip in the sequence of chips;
determining a CIR estimate for the pulse signal; and
computing the corrected CIR estimate for the pulse signal based on the correction matrix and the CIR estimate.

12. The UWB device of claim 11, wherein the computing of the correction matrix comprises:
composing a first correction-element matrix to be a Toeplitz matrix of the sequence of chips;
determining a corruption matrix from the sequence of chip, the corruption matrix being a diagonal matrix with diagonal elements being complementary of the sequence of chips;
determining a second correction-element matrix to be a transpose of the first correction-element matrix; and
computing the correction matrix to be a product of the first correction-element matrix, the corruption matrix, and the second correction-element matrix.

13. The UWB device of claim 12, wherein computing of the corrected CIR estimate for the pulse signal based on the correction matrix and the CIR estimate comprises:
determining a number of columns of the correction matrix to be N_{g}, N_{g} being less than or equal to N;
determining a reduced correction matrix to have the N rows of the correction matrix and N_{g} columns of the correction matrix;
determining an actual correction matrix by computing a pseudo-inversion of the reduced correction matrix; and
computing the corrected CIR estimate based on the actual correction matrix and the CIR estimate.

14. The UWB device of claim 13, wherein the computing of the pseudo-inversion of the reduced correction matrix comprises:
determining a first part of the correction matrix to be a first block correction matrix, the first block correction matrix having a N_{g} rows of the correction matrix and a N_{g} columns of the correction matrix;
determining a second part of the correction matrix to be a second block correction matrix, the second block correction matrix having a remaining (N−N_{g}) rows of the correction matrix and the N_{g} columns of the correction matrix; and
computing a second product of an inverted first block correction matrix and a transposed second block correction matrix.

15. The UWB device of claim 14, wherein the determining of the CIR estimate comprises:
sampling the pulse signal to obtain a plurality of samples;
filtering the plurality of samples using a correlation filter;
dividing filtered samples into one or more groups based on a grid interval of the correlation filter, each of the groups having a length of the grid interval; and
composing an initial CIR estimate from the plurality of groups, each of the one or more groups being a respective column of the initial CIR estimate.

16. The UWB device of claim 15, wherein the computing of the corrected CIR estimate comprises:
determining a first part of the initial CIR estimate to be a first partial CIR estimate, the first partial CIR estimate having a N_{g} rows of the initial CIR estimate;
determining a second part of the initial CIR estimate to be a second partial CIR estimate, the second partial CIR estimate having a remaining (N−N_{g}) rows of the initial CIR estimate; and
computing a sum of the first partial CIR estimate and a weighted third product of the second partial CIR estimate and the second product.

17. The UWB device of claim 16, wherein the weight of the third product is greater than or equal to zero, and less than or equal to 1.

18. The UWB device of claim 14, further comprising computing and storing the product of the inverted first block correction matrix and the transposed second block correction matrix prior to the computing of the CIR estimate.

19. The UWB device of claim 11, wherein the sequence of chips comprise a ternary sequence.

20. The UWB device of claim 13, wherein the computing of the corrected CIR estimate based on the actual correction matrix and the CIR estimate comprises obtaining a unique solution of the corrected CIR estimate by minimizing the least-squares error.
